(19) United States
(12) Patent Application Publication
(10) Pub. No.: US 2018/0252037 A1
(43) Pub. Date: Sep. 6, 2018

(54) DEFORMABLE HERRINGBONE LADDER WITH STRAIGHT LADDER FUNCTION

(71) Applicant: NEW-TEC INTEGRATION (XIAMEN) CO., LTD., Xiamen (CN)

(72) Inventor: Luhao Leng, Xiamen (CN)

(73) Assignee: NEW-TEC INTEGRATION (XIAMEN) CO., LTD., Xiamen (CN)

(21) Appl. No.: 15/906,770

(22) Filed: Feb. 27, 2018

(30) Foreign Application Priority Data
Mar. 3, 2017 (CN) 201710123548.9

(51) Int. Cl. E06C 1/32; E06C 1/10

(52) U.S. Cl. CPC E06C 1/32; E06C 1/10

(57) ABSTRACT

Disclosed is a deformable herringbone ladder with straight ladder function, comprising a left ladder rack, a right ladder rack and a hinge mechanism, the left ladder rack and the right ladder rack are relatively rotatable to switch the ladder between a herringbone ladder state and a straight ladder state; wherein the left ladder rack comprises two left legs and an even number of left footboards connecting the two left legs, the left footboards are parallel arranged in equal spacing, the distance between two adjacent left footboards is defined L1; the distance between two adjacent right footboards is defined L2; in the straight ladder state by rotating, the distance between the left footboard at the top portion of the left ladder rack and the right footboard at the top portion of the right ladder rack is defined L3; L1=L2=L3. The present invention conforms the Europe and America's safety technical standard.

### TECHNICAL FIELD

The present invention relate to a herringbone ladder, particularly to a herringbone ladder which can be changed to be a straight ladder.

### RELATED ART

Traditional herringbone ladder comprises a left ladder rack and a right ladder rack, the top end of the left ladder rack and the top end of the right ladder rack are rotatably hinged by a hinge. The left ladder rack and the right ladder rack are contacted together when the ladder is unused and folded. The left and right ladder rack are rotated and unfolded to form a herringbone shape to stand stably on the ground when the ladder is used.

To enrich the functions of the herringbone ladder, the traditional herringbone ladder is improved to make the left ladder rack and right ladder rack capable of rotating relatively in line to be served as a straight ladder. Therefore, the ladder has three states: the left ladder rack and the right ladder rack being folded, the left ladder rack and the right ladder rack being rotated to a herringbone ladder, the left ladder rack and the right ladder rack being rotated to a straight ladder.

But in the Europe and America's safety technical standard, a particular condition is required to the straight ladder that each step distance mush be equal. As the traditional herringbone ladder has the footboard at the top portion of the left ladder rack and the footboard at the top portion of the right ladder rack very close to each other (even overlapping) in the straight ladder state, the actual step distance of joint position of the left ladder rack and the right ladder rack is not equal to the normal step distance (the actual step distance is short, or the actual step distance is a thickness of the footboard shorter than the normal step distance, or the actual step distance is a thickness of the footboard longer than the normal step distance). Therefore, existing herringbone ladder with straight ladder function does not conform the the Europe and America's safety technical standard.

### SUMMARY OF THE INVENTION

The present invention provides a deformable herringbone ladder with straight ladder function, which has an equal step distance either in straight ladder state or in herringbone ladder state. The technical solution of the present invention is that:

A deformable herringbone ladder with straight ladder function, comprising a left ladder rack, a right ladder rack and a hinge mechanism, the top portion of the left ladder rack is connected to the top portion of the right ladder rack by the hinge mechanism, the left ladder rack and the right ladder rack are relatively rotatable to switch the ladder between a herringbone ladder state and a straight ladder state;

the left ladder rack comprises two left legs and an even number of left footboards connecting the two left legs, the left footboards are parallel arranged in equal spacing, the distance between two adjacent left footboards is defined L1; the right ladder rack comprises two right legs and an odd number of right footboards connecting the two right legs, the right footboards are parallel arranged in equal spacing, the distance between two adjacent right footboards is defined L2; in the herringbone ladder state, the rotating center of the hinge mechanism is disposed between the left ladder rack and the right ladder rack, and the height of the rotating center of the hinge mechanism is disposed between the highest point and the lowest point of the footboard at the top portion of the herringbone ladder; in the straight ladder state by rotating, the left ladder rack is in line with the right ladder rack, the distance between the left footboard at the top portion of the left ladder rack and the right footboard at the top portion of the right ladder rack is defined L3; therein L1=L2=L3.

Compared to the existing known technology, the technical solution of the present invention has advantages as follows:

The present invention has even left footboards and odd right footboards, the total number of the left and right footboards is odd; if the ladder is used as a straight ladder, the two ladder racks joint without coinciding footboards; the step distance (L1) between the left footboards, the step distance (L2) between the right footboards and the step distance (L3) between the left and right footboards are equal that conform the technical standard of safety.

### BRIEF DESCRIPTION OF THE DRAWINGS

The present invention will be further described with the drawings and embodiments.

FIG. 1 illustrates a schematic diagram of the deformable herringbone ladder with straight ladder function which can be changed to a straight ladder of the present invention in the herringbone ladder state.

FIG. 2a and 2b illustrate a side view and a schematic diagram of the herringbone ladder of FIG. 1 in folding state.

FIG. 3a and 3b illustrates a side view and a schematic diagram of the herringbone ladder of FIG. 1 in straight ladder state.

FIG. 4 illustrates an exploded diagram of the herringbone ladder of FIG. 1.

FIG. 5 illustrates an exploded diagram of the hinge of the herringbone ladder of FIG. 1.

FIG. 6 illustrates a schematic diagram of the herringbone ladder of FIG. 1 rotating from the herringbone ladder state to the straight ladder state.

FIG. 7 illustrates a schematic diagram of the left footboard or the right footboard of the herringbone ladder of the present invention.

### DETAILED DESCRIPTION OF THE EMBODIMENTS

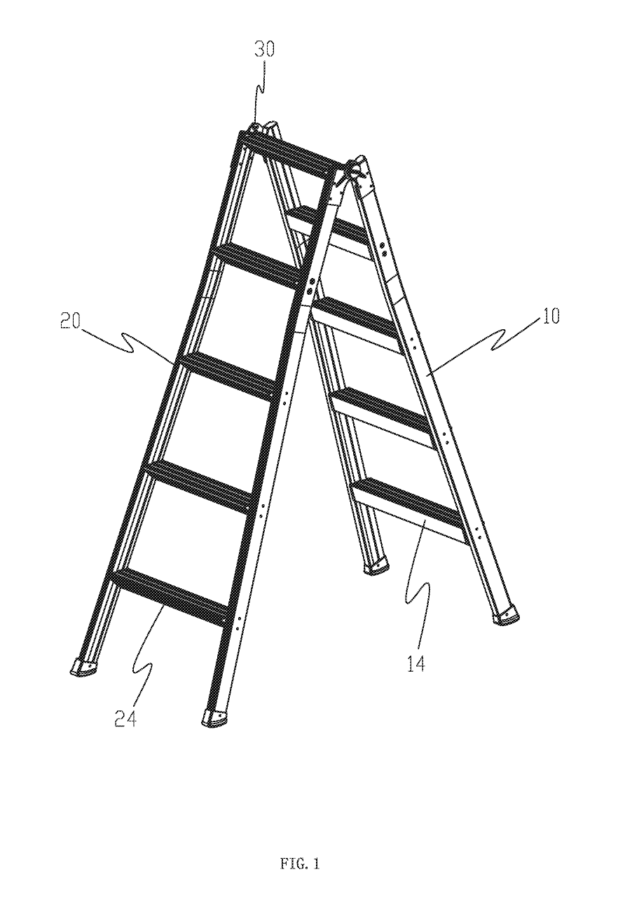

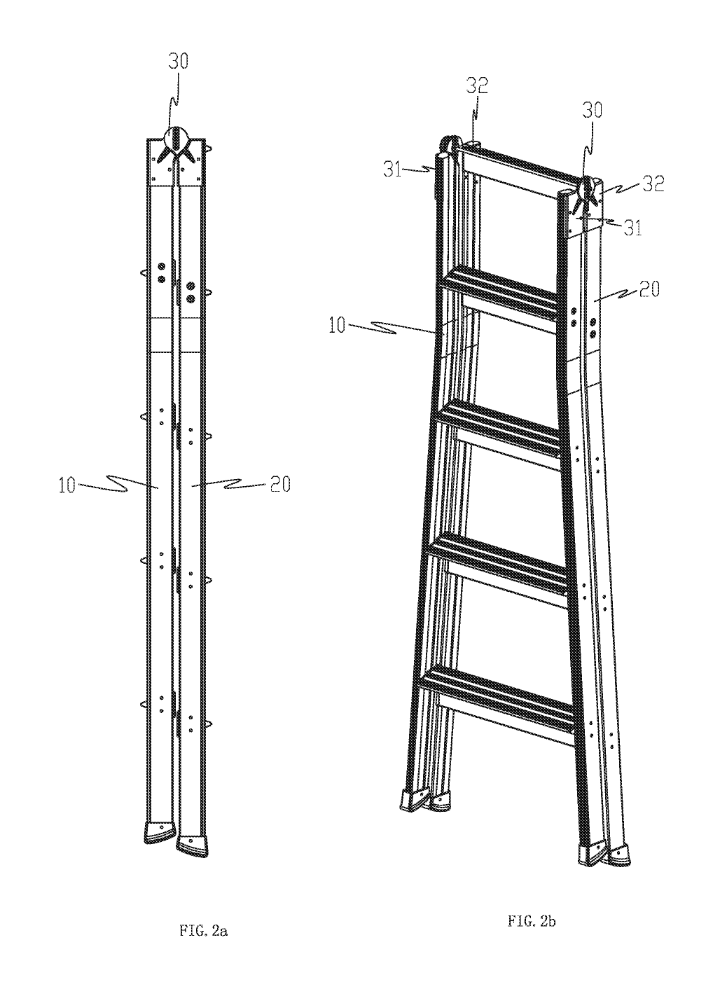

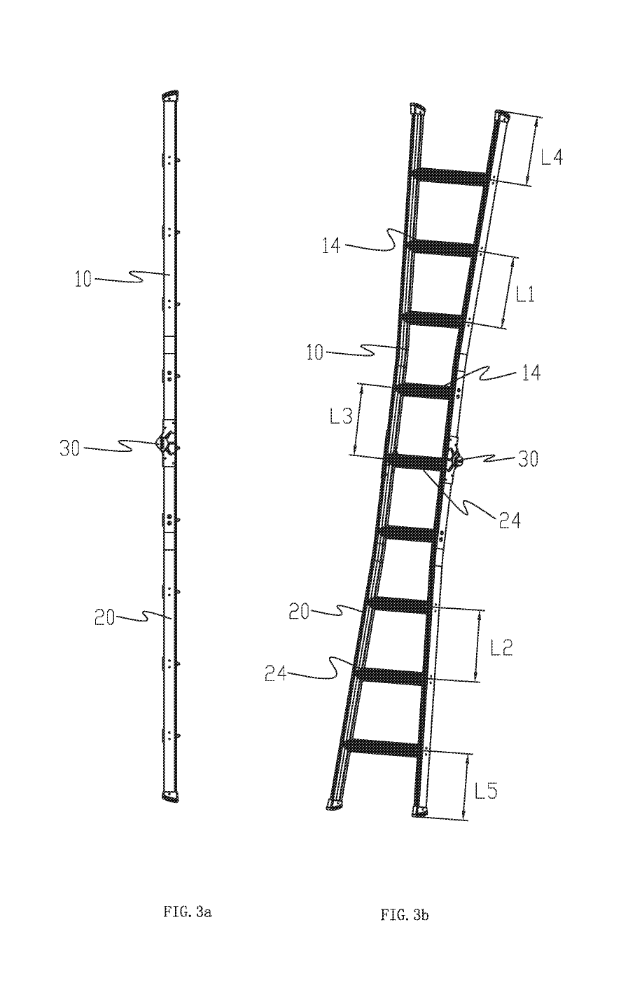

Referring to FIGS. 1-4, the deformable herringbone ladder with straight ladder function of the present invention comprises a left ladder rack 10, a right ladder rack 20 and a hinge mechanism 30, the top portion of the left ladder rack 10 is connected to the top portion of the right ladder rack 20 by the hinge mechanism 30, the left ladder rack 10 and the right ladder rack 20 are relatively rotatable to switch the ladder between a herringbone ladder state and a straight ladder state.

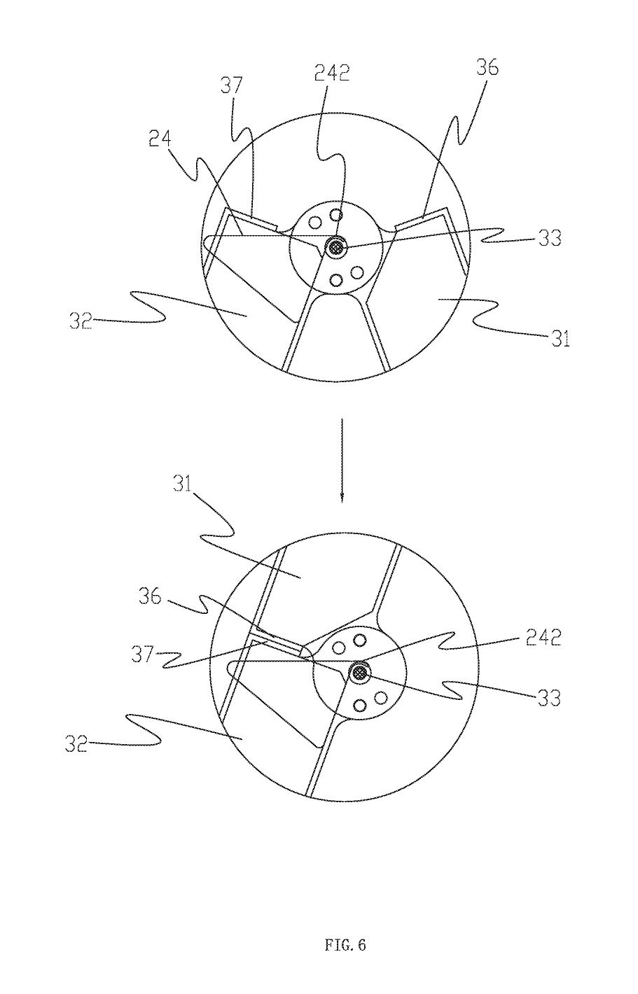

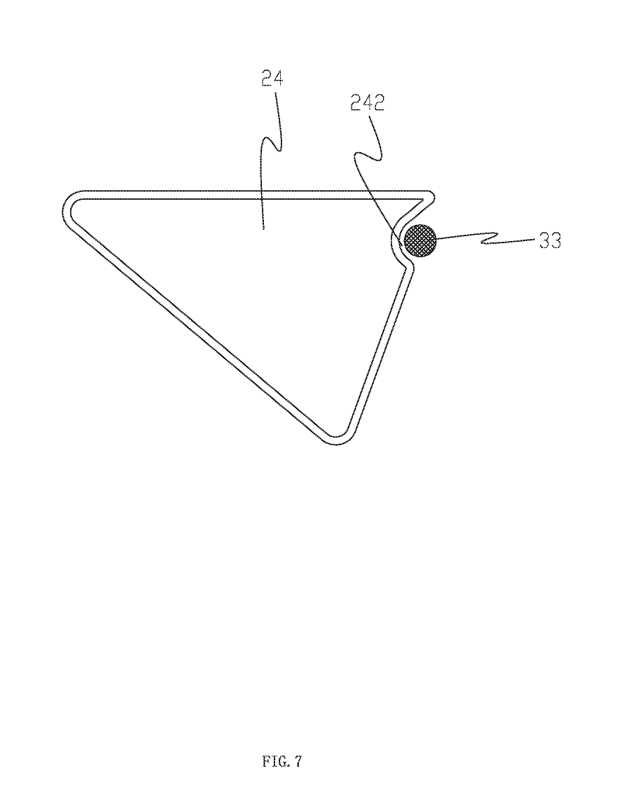

The left ladder rack 10 comprises two left legs 12 and an even number of left footboards 14 connecting the two left legs 12, the left footboards 14 are parallel arranged in equal spacing, the distance between two adjacent left footboards 14 is defined L 1 ; the right ladder rack 20 comprises two right legs 22 and an odd number of right footboards 24 connecting the two right legs 22, the right footboards 24 are parallel arranged in equal spacing, the distance between two adjacent right footboards 24 is defined L2; in the herringbone ladder state, the rotating center of the hinge mechanism 30 is disposed between the left ladder rack 10 and the right ladder rack 20, and the height of the rotating center of the hinge mechanism 30 is disposed between the highest point and the lowest point of the footboard at the top portion of the herringbone ladder (if the left footboard 14 is higher than the right footboard 24, the rotating center is between the highest point and the lowest point of the top left footboard 14; if the right footboard 24 is higher than the left footboard 14, the rotating center is between the highest point and the lowest point of the top right footboard 24, as figured in FIG. 6 and FIG. 7); in the straight ladder state by rotating, the left ladder rack 10 is in line with the right ladder rack 20, the distance between the left footboard 14 at the top portion of the left ladder rack 10 and the right footboard 24 at the top portion of the right ladder rack 20 is defined L3; therein L1=L2=L3. Therefore, the distance of each step is equal in the straight ladder state and the herringbone ladder state.

The distance between the left footboard at the bottom portion of the left ladder rack 14 and the bottom end face of the left leg 12 is defined L4, therein L4=L1; the distance between the right footboard 24 at the bottom portion of the right ladder rack 22 and the bottom end face of the right leg is defined L5, therein L5=L2. Therefore, the user can keep the same distance of step from the initial.

The thickness of the left footboard 14 is equal to the thickness of the right footboard 24, there are five right footboards 24 and four left footboards 14, the right footboards 24 have one more than the left footboards 14, the right leg 22 is one thickness of footboard longer than the left leg 12. It can be understood that, if the left footboards have one more than the right footboards, the left leg is one thickness of footboard longer than the right leg.

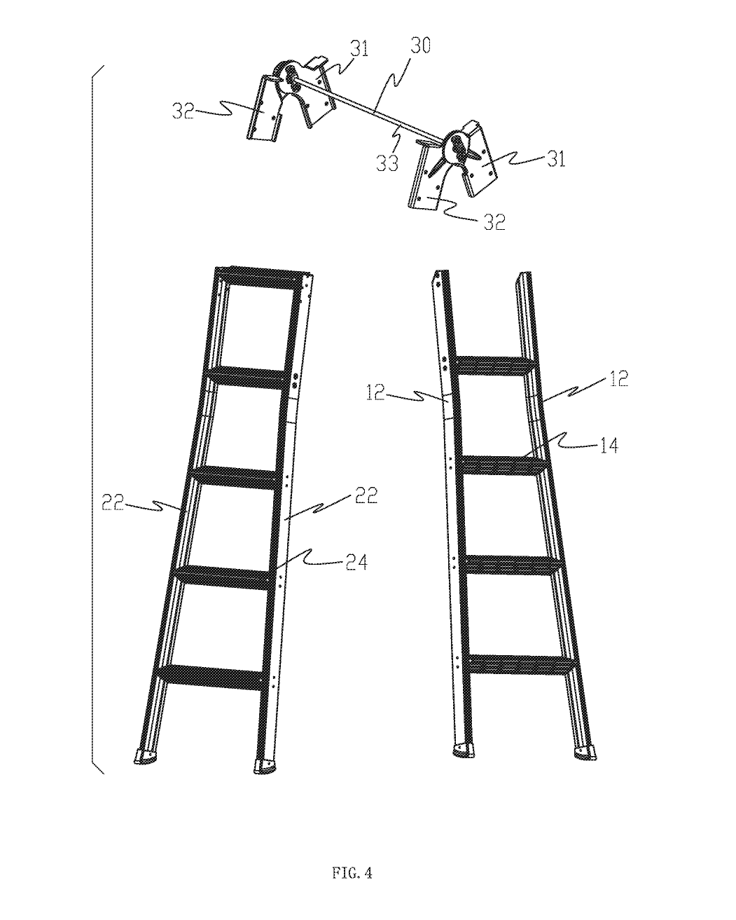

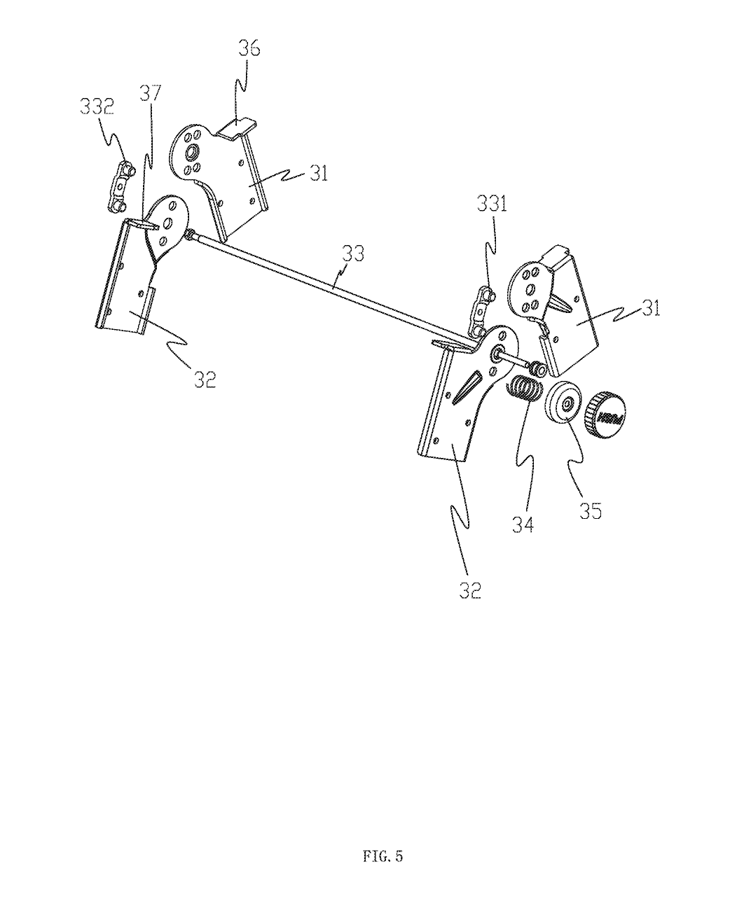

Referring to FIGS. 4-6, the hinge mechanism 30 comprises two left rotating sheets 31 respectively connected to the top portion of the two left legs 12, two right rotating sheets 32 respectively connected to the top portion of the two right legs 22, a rotating shaft 33 passing through the two left rotating sheets and the two right rotating sheets, the left rotating sheets 31 are rotatable about the rotating shaft 33, the right rotating sheets 32 are rotatable about the rotating shaft 33. The axis of the rotating shaft 33 is the rotating center of the hinge mechanism 30.

The front end portion of the rotating shaft 33 is disposed with a front insert pin 331, the rear end portion of the rotating shaft 33 is disposed with a rear insert pin 332; in folding, herringbone ladder or straight ladder state, the front insert pin 331 is inserted to one left rotating sheet 31 and one right rotating sheet 32 to restrict the relative rotation of the left and right rotating sheets, the rear insert pin 332 is inserted to the other left rotating sheet 31 and the other right rotating sheet 32 to restrict the relative rotation of the left and right rotating sheets; the rotating shaft 33 is axially movable to release the restriction on the left rotating sheets 31 and the right rotating sheets 32.

The hinge mechanism 30 further comprises an elastic spring 34, the elastic spring 34 acts an axial elastic force on the rotating shaft 33 to make the rotating shaft 33 axially move to drive the front and rear insert pin 331 and 332 to insert to the left and right rotating sheets 31 and 32. One end of the rotating shaft 33 is connected with an end cap 35, the elastic spring 34 is sleeved on the rotating shaft 33 and abuts against the end cap 35.

The end cap 35 can be pressed down by overcoming the elastic force of the spring 34 to drive the rotating shaft 33 to move to make the front insert pin 331 and the rear insert pin 332 respectively release the restrictions on the left rotating sheet 31 and the right rotating sheets 32, then the left ladder rack 10 and the right ladder rack 20 are rotatable.

The left rotating sheet 31 and the right connecting sheet 32 are contacted together, the side edge of the left rotating sheet 31 is connected with a flat board 36, the side edge of the right rotating sheet 32 is connected with a flat board 37, the flat board 36 of the left rotating sheet 31 and the flat board 37 of the right rotating sheet 32 are stacked together in straight ladder state.

The footboard 24 at the top portion of the right ladder rack 20 is disposed with a hem structure 242 to cover the rotating shaft 33 from the top, or as figured in FIG. 7, the side wall of the right footboard 24 at the top portion of the right ladder rack 20 is disposed with a groove 244 to place the rotating shaft 33. In another case, if the left footboards 14 have one more than the right footboards 24, the hem structure is disposed at the left footboard 14 at the top portion of the left ladder rack 10; or the groove is disposed at the side wall of the left footboard 14 at the top portion of the left ladder rack 10.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A deformable herringbone ladder with straight ladder function, comprising a left ladder rack, a right ladder rack and a hinge mechanism, the top portion of the left ladder rack is connected to the top portion of the right ladder rack by the hinge mechanism, the left ladder rack and the right ladder rack are relatively rotatable to switch the ladder between a herringbone ladder state and a straight ladder state; wherein the left ladder rack comprises two left legs and an even number of left footboards connecting the two left legs, the left footboards are parallel arranged in equal spacing, the distance between two adjacent left footboards is defined L1; the right ladder rack comprises two right legs and an odd number of right footboards connecting the two right legs, the right footboards are parallel arranged in equal spacing, the distance between two adjacent right footboards is defined L2; in the herringbone ladder state, the rotating center of the hinge mechanism is disposed between the left ladder rack and the right ladder rack, and the height of the rotating center of the hinge mechanism is disposed between the highest point and the lowest point of the footboard at the top portion of the herringbone ladder; in the straight ladder state by rotating, the left ladder rack is in line with the right ladder rack, the distance between the left footboard at the top portion of the left ladder rack and the right footboard at the top portion of the right ladder rack is defined L3; therein L1=L2=L3.

2. The deformable herringbone ladder with straight ladder function according to claim 1, wherein the distance between the left footboard at the bottom portion of the left ladder rack and the bottom end face of the left leg is defined L4, therein L4=L1; the distance between the right footboard at the bottom portion of the right ladder rack and the bottom end face of the right leg is defined L5, therein L5=L2.

3. The deformable herringbone ladder with straight ladder function according to claim 2, wherein the thickness of the left footboard is equal to the thickness of the right footboard, the left footboards have one more than the right footboards, the left leg is one thickness of footboard longer than the right leg.

4. The deformable herringbone ladder with straight ladder function according to claim 2, wherein the thickness of the left footboard is equal to the thickness of the right footboard, the right footboards have one more than the left footboards, the right leg is one thickness of footboard longer than the left leg.

5. The deformable herringbone ladder with straight ladder function according to claim 1, wherein the hinge mechanism comprises two left rotating sheets respectively connected to the top portion of the two left legs, two right rotating sheets respectively connected to the top portion of the two right legs, a rotating shaft passing through the two left rotating sheets and the two right rotating sheets, the left rotating sheets are rotatable about the rotating shaft, the right rotating sheets are rotatable about the rotating shaft.

6. The deformable herringbone ladder with straight ladder function according to claim 5, wherein the front end portion of the rotating shaft is disposed with a front insert pin, the rear end portion of the rotating shaft is disposed with a rear insert pin; in folding, herringbone ladder or straight ladder state, the front insert pin and rear insert pin are respectively inserted to the left and right rotating sheets to restrict the relative rotation of the left and right rotating sheets; the rotating shaft is axially movable to release the restriction on the left and right rotating sheets.

7. The deformable herringbone ladder with straight ladder function according to claim 6, wherein the hinge mechanism further comprises an elastic spring, the elastic spring acts an axial elastic force on the rotating shaft to make the rotating shaft axially move to drive the front and rear insert pin to insert to the left and right rotating sheet.

8. The deformable herringbone ladder with straight ladder function according to claim 7, wherein one end of the rotating shaft is connected with an end cap, the elastic spring is sleeved on the rotating shaft and abuts against the end cap.

9. The deformable herringbone ladder with straight ladder function according to claim 5, wherein the left rotating sheet and the right connecting sheet are contacted together, the side edge of the left rotating sheet is connected with a flat board, the flat board of the left rotating sheet and the flat board of the right rotating sheet are stacked together in straight ladder state.

10. The deformable herringbone ladder with straight ladder function according to claim 5, wherein the footboard at the top portion of the left ladder rack or the right ladder rack is disposed with a hem structure to cover the rotating shaft from the top, or the side wall of the footboard at the top portion of the left ladder rack or the right ladder rack is disposed with a groove to place the rotating shaft.
